(19) United States
(12) Patent Application Publication
(10) Pub. No.: US 2006/0082489 A1
(43) Pub. Date: Apr. 20, 2006

(54) Radar presence alert for WLAN

(76) Inventors: Jiewen Jenna Liu, San Diego, CA (US); Chih C. Tsien, San Diego, CA (US)

Correspondence Address: BLAKELY SOKOLOFF TAYLOR & ZAFMAN, 12400 WILSHIRE BOULEVARD, SEVENTH FLOOR, LOS ANGELES, CA, 90025-1030, US

(21) Appl. No.: 10/966,187

(22) Filed: Oct. 15, 2004

(51) Int. Cl. G01S 7/40; H04B 17/00

(52) U.S. Cl. 342/52; 342/20; 455/67.13

(57) ABSTRACT

In a wireless network that uses some of the same channels as radars, an operationally separate radar detection device may be used to detect the presence of a radar signal, and notify at leas one network device of that detection so the wireless network devices may switch to a non-interfering channel. In some embodiments the detection device may be physically separate from other network devices, and may notify them via network communication messages. In other embodiments, the detection device may be physically and electrically attached to a network device, and may notify that device via an interrupt or other wired connection.

### BACKGROUND

Wireless Local Area Network (WLAN) products may operate at various frequencies, such as 2.4 gigahertz (GHz) or 5 GHz. Those operating at 5 GHz must share the band with government/military radar systems, and may therefore interfere with those radar systems. Because reliable operation of the radar is considered a higher priority use than the consumer or commercial use of WLAN, WLAN systems may be required to monitor for radar signals. When a radar signal is detected, the WLAN system may be required to switch to a non-interfering channel.

In conventional systems the base station, or access point (AP), may be responsible for monitoring for radar signals, and may further be required to redirect all communications to a new channel within a defined time when a radar signal is detected. However, because the AP generally handles all communications within the WLAN, when the WLAN is in a heavy traffic condition the overworked AP may have to choose between monitoring for radar signals and keeping the flow of communications going. The choice that is made may affect whether network performance suffers, or the AP misses a radar signal and possibly interferes with the radar.

### BRIEF DESCRIPTION OF THE DRAWINGS

The invention may be understood by referring to the following description and accompanying drawings that are used to illustrate embodiments of the invention. In the drawings:

FIG. 1 shows a diagram of a network using a physically separate radar detection device, according to an embodiment of the invention.

FIG. 2 shows a flow diagram of a method of operating the radar detection device of FIG. 1, according to an embodiment of the invention.

FIG. 3 shows a diagram of a network using a radar detection device disposed in the same package with a network device, according to an embodiment of the invention.

FIG. 4 shows a flow diagram of a method of operating the radar detection device of FIG. 3, according to an embodiment of the invention.

### DETAILED DESCRIPTION OF THE INVENTION

In the following description, numerous specific details are set forth. However, it is understood that embodiments of the invention may be practiced without these specific details. In other instances, well-known circuits, structures and techniques have not been shown in detail in order not to obscure an understanding of this description.

References to “one embodiment”, “an embodiment”, “example embodiment”, “various embodiments”, etc., indicate that the embodiment(s) of the invention so described may include a particular feature, structure, or characteristic, but not every embodiment necessarily includes the particular feature, structure, or characteristic. Further, repeated use of the phrase “in one embodiment” does not necessarily refer to the same embodiment, although it may.

In the following description and claims, the terms “coupled” and “connected,” along with their derivatives, may be used. It should be understood that these terms are not intended as synonyms for each other. Rather, in particular embodiments, “connected” may be used to indicate that two or more elements are in direct physical or electrical contact with each other. “Coupled” may mean that two or more elements are in direct physical or electrical contact. However, “coupled” may also mean that two or more elements are not in direct contact with each other, but yet still co-operate or interact with each other.

The term “processor” may refer to any device or portion of a device that processes electronic data from registers and/or memory to transform that electronic data into other electronic data that may be stored in registers and/or memory. A “computing platform” may comprise one or more processors.

As used herein, unless otherwise specified the use of the ordinal adjectives “first”, “second”, “third”, etc., to describe a common object, merely indicate that different instances of like objects are being referred to, and are not intended to imply that the objects so described must be in a given sequence, either temporally, spatially, in ranking, or in any other manner.

In the context of this document, the term “wireless” and its derivatives may be used to describe circuits, devices, systems, methods, techniques, communications channels, etc., that may communicate data through the use of modulated electromagnetic radiation through a non-solid medium. The term does not imply that the associated devices do not contain any wires, although in some embodiments they might not.

Various embodiments of the invention may be implemented in one or a combination of hardware, firmware, and software. The invention may also be implemented as instructions stored on a machine-readable medium, which may be read and executed by a processing platform to perform the operations described herein. A machine-readable medium may include any mechanism for storing, transmitting, or receiving information in a form readable by a machine (e.g., a computer). For example, a machine-readable medium may include read only memory (ROM); random access memory (RAM); magnetic disk storage media; optical storage media; flash memory devices; electrical, optical, acoustical or other form of propagated signals (e.g., carrier waves, infrared signals, digital signals, the interfaces and/or antennas that transmit and/or receive those signals, etc.), and others.

Various embodiments of the invention involve using an independent radar detection device (i.e., not one of the existing wireless network devices that just performs radar detection in addition to its normal network communications operations) to monitor for the existence of a radar signal and notify the network when a radar signal is detected so that the network may subsequently use a channel that doesn't interfere with the radar. However, the radar detection device may be incorporated in the same electronic package as the wireless network device, provided the two devices are operationally separate, and may notify the network device by direct means, such as an interrupt. Alternately, the radar detection device may be in a separate package, and may notify the network by transmitting that notice in a wireless message, to one or more of the network devices in the network.

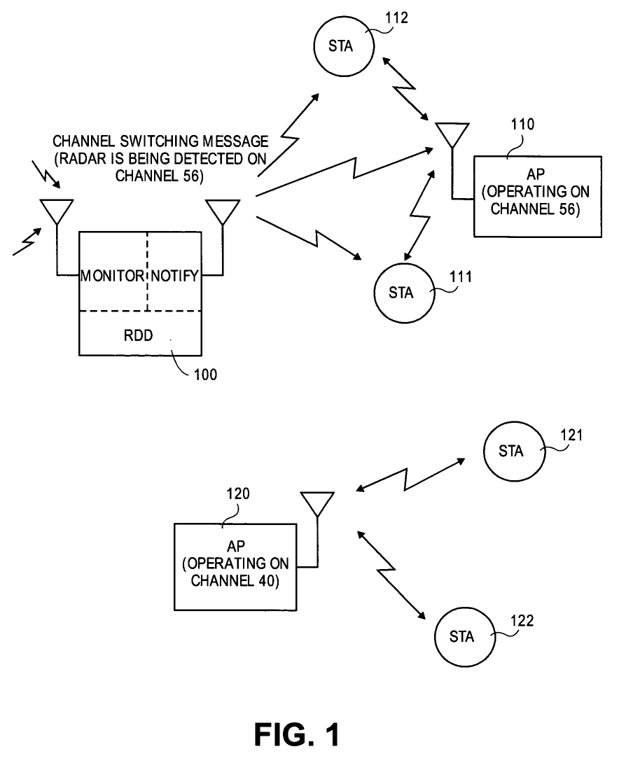

FIG. 1 shows a diagram of a network using a physically separate radar detection device, according to an embodiment of the invention. In the illustrated example, an AP 110 is shown communicating with two STAs (111, 112) over channel 56 and a separate AP 120 is shown communicating with two other STAs (121, 122) over channel 40. Although in some embodiments the term ‘channel’ may refer to communications that occur over a single frequency or frequency band, in other embodiments the term ‘channel’ may refer to communications that are spread over multiple frequencies or frequency bands. Although two APs with two STAs each are shown for simplicity, other quantities of each are also contemplated. Also shown is a physically separate radar detection device (RDD) 100. RDD 100 may have monitor circuitry to monitor for radar signals on all the channels that might be used by AP 110 and/or AP 120 and the associated STAs. Such monitoring may comprise detecting radar signals that are at or above a defined signal strength on a channel. Distinguishing between radar signals and other types of signals may be accomplished by any feasible method currently known or yet to be developed. RDD 100 may also have notification circuitry to notify one or more other devices in the network of the presence of a radar signal. In the illustrated embodiment a single antenna is shown for receiving radar signals and a single antenna is shown for communicating with the network devices, but in some embodiments multiple antennas may be used to receive radar signals and/or multiple antennas may be used to communicate with the network devices. In the illustrated embodiment separate antennas are shown for receiving radar signals and for communicating with network devices, but in some embodiments the same antenna(s) may be used for both operations.

When the RDD detects a radar signal on one of the channels, and the radar signal has a signal strength above some threshold value (if the radar is too distant from the network for interference to be a factor, there may be no need to take action even if a radar signal is detected), the RDD may notify the network devices so that those network devices may switch to a non-interfering channel, or avoid switching to the interfering channel if they are already on a non-interfering channel. In one embodiment the RDD may communicate the presence of a radar signal directly to all network devices that are capable of receiving such direct notification. In another embodiment, the RDD may communicate the presence of a radar signal to a single network device, such as an AP, and the notified network device may then communicate the presence of a radar signal to the other affected network devices. In still another embodiment the RDD may communicate the presence of a radar signal to all APs in the area but not to the mobile devices that are communicating with those APs. The illustrated example shows RDD 100 notifying only AP 110 and STAs 111, 112 that a radar has been detected on channel 56, since only those devices are currently operating on channel 56. Such selective notification may require that RDD 100 monitor network communications so that it knows which devices are operating on which channels, but other embodiments may not be as selective in the notification process, and allow the notified network devices to determine if they are operating on the channel on which radar signals were detected.

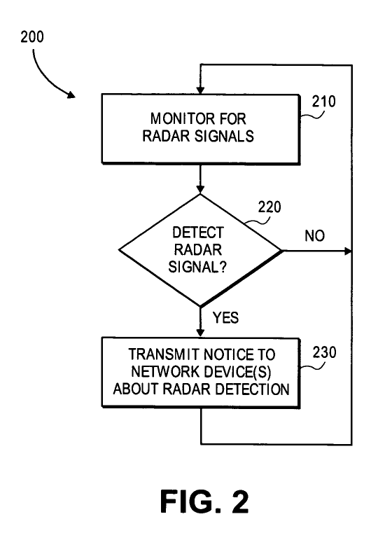

FIG. 2 shows a flow diagram of a method of operating the radar detection device of FIG. 1, according to an embodiment of the invention. In flow chart 200, an RDD may monitor for radar signals at 210. Such radar signals may occur on various channels, and the RDD may monitor all such channels that coincide with channels that the wireless network might use. Alternately, the RDD may monitor only those channels that the wireless network is actually using, or is planning to use imminently (e.g., before an AP switches to a new channel, it might request the RDD to monitor that channel for radar signals and report back its findings). In one embodiment the RDD may serially scan through the various channels of interest, while in another embodiment the RDD may have parallel monitoring capability that allows it to monitor multiple channels simultaneously. Still another embodiment may permit a hybrid combination of these techniques (e.g., multiple sets of multiple-channel monitors).

As long as no radar signal is detected at 220 (where ‘detect’ implies identifying a radar signal that is stronger than a predetermined threshold value), the monitoring operation may continue. If a radar signal is detected on any channel of interest at 230, the RDD may transmit a message to one or more network devices notifying them of the fact that a radar signal was detected on a specified channel. As previously described the notification may be directed to one, several, or all of the network devices that can receive such a message. In some embodiments the message may also include information about what channels are free of radar signals and/or what other channels radar signals are being detected on, so that the network devices may make intelligent decisions about which channels may be used without the risk of interfering with any radar.

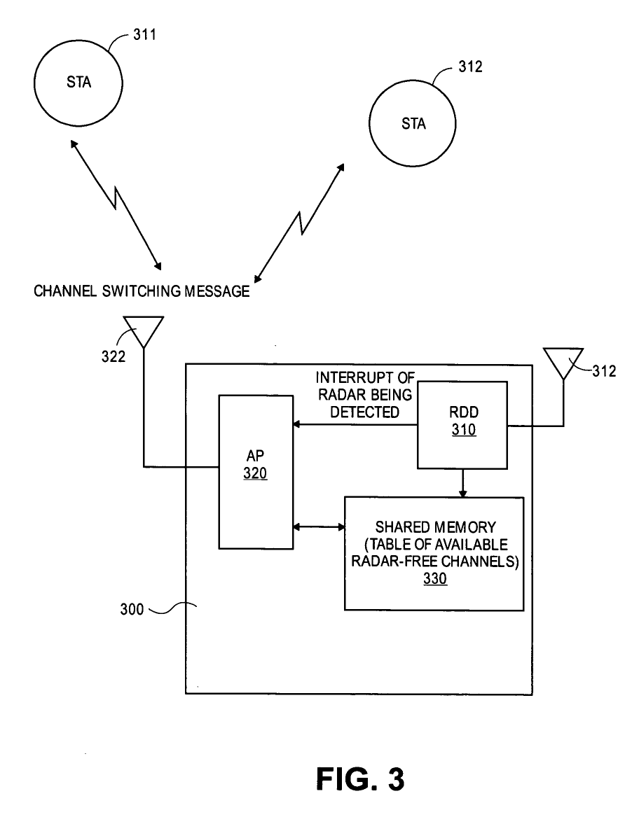

FIG. 3 shows a diagram of a network using a radar detection device disposed in the same package with a network device, according to an embodiment of the invention. In the illustrated embodiment the RDD 310 is contained in the same physical package 300 as the AP 320, although the hardware/software providing the functionality of the RDD may be substantially separate from the hardware/software providing the functionality of the AP. Such separate functionality may be achieved by using one processor in the RDD and a separate processor in the AP, a configuration that may already be inherent in the system shown in FIG. 1. The illustrated embodiment shows a storage element, such as but not limited to a shared memory, in which the RDD may keep a table of channels that are radar-free, or channels that should not be used by the network because a radar is using them, or both. The AP may be able to read this table to determine which channels should be avoided. In the illustrated embodiment the RDD may notify the AP that a radar signal has just been detected by generating an interrupt to the AP (e.g., to a GPIO interrupt pin on a processor chip), and the AP may react by examining the table in storage element 330 to determine which channel(s) should be avoided by the network. In other embodiments the AP may learn of the detection of a radar signal through other means, such as by sending one or more non-interrupt signals from the RDD to the AP. Whatever means is used, once the AP is aware that some of the network devices need to change channels, the AP may send a message to those network devices (e.g., STAs 311, 312) to change to a specified channel for any further communications.

The illustrated embodiment shows that AP 320 has one or more antennas 322 for communicating with other network devices, while the RDD 310 has its own one or more antennas 312 for detecting radar signals, although other embodiments may use other techniques (e.g., AP 320 and RDD 310 may share the same antenna(s), although this might put restrictions on when the RDD is able to monitor).

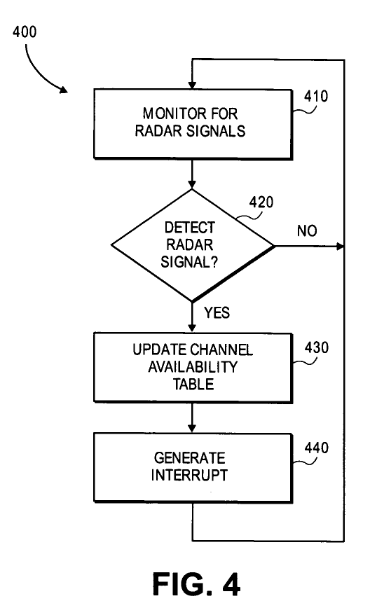

FIG. 4 shows a flow diagram of a method of operating the radar detection device of FIG. 3, according to an embodiment of the invention. In flow diagram 400, the RDD may monitor for radar signals at 410, and the monitoring may continue as long as no radar signals are detected at 420 on the channels of interest. Various monitoring techniques may be used, as previously described. If a radar signal of sufficient strength is detected at 420, the RDD may update the channel availability table at 430. Subsequent to updating the table, the RDD may notify the AP that a radar signal has been detected on a current operating channel through a direct-wired technique, such as by generating an interrupt to the AP at 440. The RDD may then resume monitoring while the AP takes action on the interrupt, such as but not limited to examining the table and sending out a channel switching message to its service set.

The foregoing description is intended to be illustrative and not limiting. Variations will occur to those of skill in the art. Those variations are intended to be included in the various embodiments of the invention, which are limited only by the spirit and scope of the appended claims.

What is claimed is:

1. An apparatus, comprising:
a radar detection device to detect a presence of a radar signal on any of multiple radar channels, the radar detection device comprising notification circuitry to notify a wireless network device of said detection of the presence of the radar signal on said any of the multiple radar channels, responsive to said detection;
wherein the radar detection device comprises a first processor separate from a second processor in the wireless network device.

2. The apparatus of claim 1, wherein the radar detection device comprises monitor circuitry to monitor the multiple radar channels for the radar signal.

3. The apparatus of claim 1, wherein the radar detection device is disposed in a same package as the wireless network device.

4. The apparatus of claim 3, wherein the notification circuitry comprises an interrupt generation circuit to generate an interrupt to the wireless network device responsive to said detection.

5. The apparatus of claim 1, wherein the notification circuitry comprises a wireless transmission circuit to wirelessly transmit the notification to the wireless network device.

6. The apparatus of claim 1, wherein the notification circuitry is to notify the wireless network device of identification of a channel on which the radar signal was detected.

7. The apparatus of claim 1, wherein the notification circuitry is to notify multiple wireless network devices of identification of a channel on which the radar signal was detected.

8. The apparatus of claim 1, wherein said detection comprises detecting that the radar signal is stronger than a particular value.

9. An apparatus, comprising
a wireless network device to receive, from a radar detection device, a notification of a detected radar signal on a particular channel, the wireless network device further to notify other wireless network devices to operate on a different channel than the particular channel;
wherein the wireless network device and the radar detection device comprise separate processors.

10. The apparatus of claim 9, wherein the notification comprises an identification of the particular channel.

11. The apparatus of claim 9, wherein the wireless network device comprises an interrupt circuit to receive an interrupt from the radar detection device, responsive to the radar detection device detecting the radar signal.

12. The apparatus of claim 11, further comprising a storage element coupled to the wireless network device and the radar detection device, the storage element to contain a table indicating at least one channel on which radar signals have been detected.

13. The apparatus of claim 9, wherein the wireless network device comprises a wireless receiver to receive a message from the radar detection device notifying the wireless network device of the detected radar signal.

14. A system, comprising
a wireless network device; and
a radar detection device having a separate processor than the wireless network device, the radar detection device comprising a communications circuit to communicate a notification from the radar detection device to the wireless network device, responsive to detection of a radar signal on any of particular channels by the radar detection device.

15. The system of claim 14, wherein the radar detection device and the wireless network device are disposed in a same package, and the radar detection device is to notify the wireless network device via a wire signal.

16. The system of claim 14, wherein the radar detection device is to notify the wireless network device via a wireless message.

17. The system of claim 16, wherein the radar detection device is to notify multiple wireless network devices via wireless messages.

18. A method, comprising
detecting a radar signal on a particular radar channel with a radar detection device;
notifying a wireless network device of the detection by performing an operation selected from a list consisting of:
1) generating an interrupt to the wireless network device; and
2) transmitting a wireless message to the wireless network device.

19. The method of claim 18, wherein said detecting comprises monitoring multiple radar channels.

20. The method of claim 18, wherein said detecting comprises detecting a signal strength of the radar signal that is above a predetermined value.

21. The method of claim 18, wherein said notifying comprises placing an identifier of the particular radar channel in a table.

22. An article comprising
a machine-readable medium that provides instructions, which when executed by a processing platform, cause said processing platform to perform operations comprising:
detecting a radar signal on a particular radar channel with a radar detection device;
notifying a wireless network device of the detection by performing an operation selected from a list consisting of:
1) generating an interrupt to the wireless network device; and
2) transmitting a wireless message to the wireless network device.

23. The article of claim 22, wherein said detecting comprises monitoring multiple radar channels.

24. The article of claim 22, wherein said detecting comprises detecting that a signal strength of the radar signal is above a predetermined threshold value.

25. The article of claim 22, wherein said notifying comprises placing an identifier of the particular radar channel in a table
